(19) United States
(12) Patent Application Publication
(10) Pub. No.: US 2006/0041042 A1
(43) Pub. Date: Feb. 23, 2006

(54) Fire-protection coating

(75) Inventors: Volker Thewes, Erftstadt (DE); Achim Hennemann, Hofheim (DE)

Correspondence Address: CLARIANT CORPORATION;INTELLECTUAL PROPERTY DEPARTMENT, 4000 MONROE ROAD, CHARLOTTE, NC, 28205, US

(73) Assignee: Clariant GmbH

(21) Appl. No.: 11/205,832

(22) Filed: Aug. 17, 2005

(30) Foreign Application Priority Data
Aug. 17, 2004 (DE) 10 2004 039 758.9

(51) Int. Cl. C08K 5/49

(52) U.S. Cl. 524/115

(57) ABSTRACT

The invention relates to a fire-protection coating which forms an insulating layer, which comprises a flame retardant mixture which comprises a phosphorus/nitrogen flame retardant and comprises a phosphinic salt of the formula (I) and/or comprises a diphosphinic salt of the formula (II) and/or comprises polymers of these, 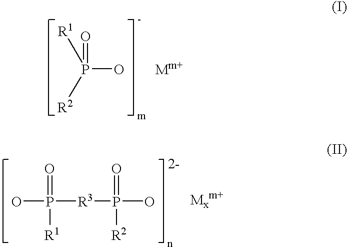 where
R¹, R² are identical or different and are C₁-C₆-alkyl, linear or branched, and/or aryl;
R³ is C₁-C₁₀-alkylene, linear or branched, C₆-C₁₀-arylene, -alkylarylene or -arylalkylene; M is Mg, Ca, Al, Sb, Sn, Ge, Ti, Zn, Fe, Zr, Ce, Bi, Sr, Mn, Li, Na, K and/or a protonated nitrogen base; m is from 1 to 4; n is from 1 to 4 and x is from 1 to 4.

The present invention is described in the German priority application No. 10 2004 039 758.9, filed 17.08.2004, which is hereby incorporated by reference as is fully disclosed herein.

The invention relates to a fire-protection coating which forms an insulating layer and is based on substances which in the event of a fire form a foam layer and carbonize, and on film-forming binders, on blowing agents, and on conventional auxiliaries and additives.

A feature of fire-protection coatings which form an insulating layer, also termed intumescent coatings, is that in the event of a fire they foam on exposure to an appropriate temperature, and that this foaming of the abovementioned fire-protection coating prevents, or at least inhibits, transfer of heat to steel structures, ceilings, walls, cables, pipes, and the like.

U.S. Pat. No. 4,965,296 describes a flame-retardant material which is composed of a flame-retardant coating material and of an electrically conductive material. The flame-retardant coating material here is composed of substances which form foam and carbonize, of a compound which generates gas, of a film-forming binder, and of appropriate solvents. Other conventional ingredients may optionally be present.

U.S. Pat. No. 4,879,320 describes a similar flame-retardant composition to which, instead of a conductive material, a ceramic fiber material has been added.

U.S. Pat. No. 6,096,812 describes an intumescent coating based on epoxy resins and having a particularly low specific density of the dried film.

These coatings are mainly used to protect ships, oil platforms, and other equipment for storage and processing of inflammable hydrocarbons. This equipment generally requires a large amount of fire-protection material in order to ensure adequate insulation of the metallic components. This automatically leads to a significant increase in the weight imposed upon the structures to be protected. However, the additional weight imposed on the load-bearing and non-load-bearing metal structures is often subject to limits (e.g. on oil platforms).

The aim of the abovementioned fire-protection coatings of the prior art is to achieve maximum fire resistance times with minimum application quantities.

One approach to smaller application quantities can be achieved by way of a reduction in the specific density of the dried film (U.S. Pat. No. 6,096,812). A disadvantage is that there is often an attendant reduction in fire-protection performance.

An overall disadvantage with the abovementioned fire-protection coatings is that the foam structures formed in the event of a fire do not permit any improvement in insulating effect, and that the reaction does not begin until temperatures T≧180° C. have been reached.

Indeed, in many cases the reaction does not begin until temperatures relatively far above this threshold have been reached.

It is therefore an object of the invention hereinafter to provide fire-protection coatings which achieve longer fire-resistance times for an identical application quantity, or achieve identical fire-resistance times for a reduced application quantity, when comparison is made with the prior art.

This object is achieved via a fire-protection coating whose reaction begins at temperatures T<180° C. (i.e. below 180° C.).

The invention therefore provides a fire-protection coating which forms an insulating layer, which comprises a flame retardant mixture which comprises a phosphorus/nitrogen flame retardant and comprises a phosphinic salt of the formula (I) and/or comprises a diphosphinic salt of the formula (II) and/or comprises polymers of these, 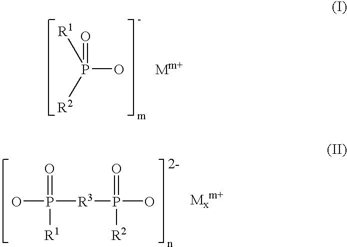
where
R¹, R² are identical or different and are C₁-C₆-alkyl, linear or branched, and/or
   aryl;
R³ is C₁-C₁₀-alkylene, linear or branched, C₆-C₁₀-arylene, -alkylarylene or
   -arylalkylene;
M is Mg, Ca, Al, Sb, Sn, Ge, Ti, Zn, Fe, Zr, Ce, Bi, Sr, Mn, Li, Na, K and/or a protonated nitrogen base;
m is from 1 to 4; n is from 1 to 4 and x is from 1 to 4.

The phosphorus/nitrogen flame retardants are preferably nitrogen-containing phosphates of the formulae (NH₄)_{y} H3-y PO4 or (NH4 PO₃)z, where y is from 1 to 3 and z is from 1 to 10 000.

The phosphorus/nitrogen flame retardants are particularly preferably ammonium hydrogenphosphate, ammonium dihydrogenphosphate, and/or ammonium polyphosphate.

The phosphorus/nitrogen flame retardants are preferably ammonium polyphosphate of the formula (NH₄PO₃)ₙ, where n is a number from 10 to ≦1000, preferably from 200 to ≦1000.

Other preferred phosphorus/nitrogen flame retardants are reaction products of melamine with phosphoric acid or with condensed phosphoric acids, or are reaction products of condensates of melamine with phosphoric acid or with condensed phosphoric acids, or are a mixture of these products.

The phosphorus/nitrogen flame retardants are particularly preferably melam, melem, or melon, dimelamine phosphate, dimelamine pyrophosphate, melamine phosphate, melamine pyrophosphate, melamine polyphosphate, melam polyphosphate, melon polyphosphate, and/or melem polyphosphate, or are mixed polysalts thereof.

The inventive fire-protection coating which forms an insulating layer preferably comprises the phosphorus/nitrogen flame retardant and the phosphinic salt of the formula (I) and/or comprises the diphosphinic salt of the formula (II) and/or comprises polymers of these, in a ratio by weight of from 0.1 to 100 (phosphorus/nitrogen flame retardant) to from 100 to 0.1 (phosphinic salt).

The inventive fire-protection coating which forms an insulating layer preferably comprises the phosphorus/nitrogen flame retardant and the phosphinic salt of the formula (I) and/or comprises the diphosphinic salt of the formula (II) and/or comprises polymers of these, in a ratio by weight of from 1 to 50 (phosphorus/nitrogen flame retardant) to from 50 to 1 (phosphinic salt).

The inventive fire-protection coating which forms an insulating layer preferably comprises
A) from 1 to 99% by weight of an epoxy resin, and
B) from 1 to 99% by weight of a flame retardant mixture which comprises a phosphorus/nitrogen flame retardant and comprises a phosphinic salt of the formula (I), and/or comprises a diphosphinic salt of the formula (II), and/or comprises polymers of these,
C) from 0 to 60% by weight of other additives.

The inventive fire-protection coating which forms an insulating layer particularly preferably comprises
A) from 10 to 90% by weight of an epoxy resin, and
B) from 2 to 60% by weight of a flame retardant mixture which comprises a phosphorus/nitrogen flame retardant and comprises a phosphinic salt of the formula (I), and/or comprises a diphosphinic salt of the formula (II), and/or comprises polymers of these,
C) from 3 to 45% by weight of other additives.

The inventive fire-protection coating which forms an insulating layer also particularly preferably comprises
A) from 30 to 85% by weight of an epoxy resin, and
B) from 3 to 50% by weight of a flame retardant mixture which comprises a phosphorus/nitrogen flame retardant and comprises a phosphinic salt of the formula (I), and/or comprises a diphosphinic salt of the formula (II), and/or comprises polymers of these,
C) from 5 to 40% by weight of other additives.

The inventive fire-protection coating which forms an insulating layer in particular also comprises from 0 to 60% by weight of additives, such as accelerators, fillers, auxiliaries, blowing agents, nitrogen synergists, carbon donors, pigments, flexibilizers, and/or reactive diluents, and also, if appropriate, other additives. The total of the entirety of the components here always amounts to 100% by weight.

M is preferably calcium, aluminum, or zinc.

It is preferable that R¹ and R² are identical or different and are methyl, ethyl, n-propyl, isopropyl, n-butyl, tert-butyl, n-pentyl, and/or phenyl.

It is preferable that R³ is methylene, ethylene, n-propylene, isopropylene, n-butylene, tert-butylene, n-pentylene, n-octylene, or n-dodecylene; phenylene or naphthylene; methylphenylene, ethylphenylene, tert-butylphenylene, methylnaphthylene, ethylnaphthylene or tert-butylnaphthylene; phenylmethylene, phenylethylene, phenylpropylene, or phenylbutylene.

Protonated nitrogen bases are preferably the protonated bases of ammonia, melamine, and triethanolamine, in particular NH₄⁺.

It is particularly preferable that R¹ and R² are identical or different and are methyl, ethyl, n-propyl, isopropyl, n-butyl, tert-butyl, n-pentyl, and/or phenyl.

The halogen-free epoxy compounds used according to the invention (hereinafter also termed polyepoxy compounds) may be saturated or unsaturated compounds, and may also be aliphatic, cycloaliphatic, aromatic, and/or heterocyclic compounds. They may moreover contain substituents which do not give rise to any problematic side reactions under the mixing conditions or reaction conditions, examples being alkyl substituents, aryl substituents, ether groups, or the like. It is also possible to use mixtures of various polyepoxy compounds. The average molecular weight Mn of these polyepoxy compounds can be up to about 9000, but is generally from about 150 to 4000.

By way of example, these polyepoxy compounds are polyglycidyl ethers based on polyhydric, preferably dihydric, alcohols, phenols, hydrogenation products of these phenols, and/or on novolaks (reaction products of mono- or polyhydric phenols, such as phenol and/or cresols, with aldehydes, in particular formaldehyde, in the presence of acidic catalysts), these being obtained in a known manner, e.g. via reaction of the respective polyols with epichlorohydrin.

Examples which may be mentioned here of polyhydric phenols are: resorcinol, hydroquinone, 2,2-bis(4-hydroxyphenyl)propane (bisphenol A), isomer mixtures of dihydroxydiphenylmethane (bisphenol F), 4,4′-dihydroxydiphenylcyclohexane, 4,4′-dihydroxy-3,3′-dimethyldiphenylpropane, 4,4-dihydroxybiphenyl, 4,4′-dihydroxy-benzophenone, 1,1-bis(4-hydroxyphenyl)ethane, 1,1′-bis(4-hydroxyphenyl)isobutane, 2,2-bis(4-hydroxy-tert-butylphenyl)propane, bis(2-hydroxynaphthyl)methane, 1,5-dihydroxynaphthalene, tris(4-hydroxyphenyl)methane, bis(4-hydroxyphenyl) 1,1′-ether.

Preference is given here to bisphenol A and bisphenol F.

Other suitable polyepoxy compounds are the polyglycidyl ethers of polyhydric aliphatic alcohols. Examples which may be mentioned of these polyhydric alcohols are 1,4-butanediol, 1,6-hexanediol, polyalkylene glycols, glycerol, trimethylolpropane, 2,2-bis(4-hydroxycyclohexyl)propane and pentaerythritol.

Other polyepoxy compounds which may be used are (poly)glycidic esters obtained via reaction of epichlorohydrin or of similar epoxy compounds with an aliphatic, cycloaliphatic, or aromatic polycarboxylic acid, e.g. oxalic acid, adipic acid, glutaric acid, phthalic acid, isophthalic acid, terephthalic acid, tetrahydrophthalic acid, or hexahydrophthalic acid, or naphthalene-2,6-dicarboxylic acid, or dimerized fatty acids. Examples here are diglycidyl terephthalate and diglycidyl hexahydrophthalate.

It is also advantageous in some cases to use polyepoxy compounds which contain the epoxy groups randomly distributed across the molecular chain and which can be prepared via emulsion copolymerization, using olefinically unsaturated compounds containing these epoxy groups, e.g. glycidyl esters of acrylic or methacrylic acid.

Examples of other polyepoxy compounds which may be used are those based on heterocyclic ring systems, e.g. hydantoin epoxy resins, triglycidyl isocyanurate, and/or its oligomers, triglycidyl-p-aminophenol, triglycidyl-p-aminodiphenyl ether, tetraglycidyldiaminodiphenylmethane, tetraglycidyidiaminodiphenyl ether, tetrakis(4-glycidoxyphenyl)ethane, urazole epoxides, uracil epoxides, oxazolidinone-modified epoxy resins, and polyepoxides based on aromatic amines, such as alanine, e.g. N,N-diglycidylaniline, diaminodiphenylmethane, and N,N′-dimethylaminodiphenylmethane or N,N′-dimethylaminodiphenyl sulfone. Other suitable polyepoxy compounds are described in “Handbook of Epoxy Resins” by Henry Lee and Kris Neville, McGraw-Hill Book Company, 1967, in the monograph by Henry Lee “Epoxy Resins” American Chemical Society, 1970, in Wagner/Sarx, “Lackkunstharze” [Synthetic Paint Resins], Carl Hanser Verlag (1971), 5th edition, pp. 174-196 in “Angew. Makromol. Chemie”, Vol. 44 (1975), pp. 151-163, in DE-A-27 57 733 and in EP-A-0 384 939, which are incorporated herein by way of reference.

Preferred polyepoxide compounds are bisglycidyl ethers based on bisphenol A, bisphenol F or bisphenol S (reaction products of these bisphenols with epichloro(halo)hydrin) or oligomers of these, polyglycidyl ethers of phenol-formaldehyde and/or cresol-formaldehyde novolaks, or diglycidyl esters of phthalic, isophthalic, terephthalic, tetrahydrophthalic and/or hexahydrophthalic acid or of trimellitic acid, N-glycidyl compounds of aromatic amines or of heterocyclic nitrogenous bases, such as N,N-diglycidylaniline, N,N,O-triglycidyl-p-aminophenol, triglycidyl isocyanurate or N,N,N′,N-tetraglycidyl-bis(p-aminophenyl)methane, hydantoin epoxy resins or aracid epoxy resins or di- or polyglycidyl compounds of polyhydric aliphatic alcohols, such as 1,4-butanediol, trimethylolpropane or polyalkylene glycols. Oxazolidinone-modified epoxy resins are also suitable. Compounds of this type are already known (see: “Angew. Makromol. Chem., Vol. 44 (1975), pp. 151-163, and U.S. Pat. No. 3,334,110); the reaction product of bisphenol A diglycidyl ether with diphenylmethane diisocyanate (in the presence of a suitable accelerator) may be mentioned as an example.

The polyepoxy resins may be present individually or in a mixture during the preparation of the inventive fire-protection coating. Hardener components which may be used are aliphatic and aromatic polyamines. Aromatic polyamines are described by way of example in EP-A-0 274 646. They are prepared via trimerization of 2,6- or 2,4-diisocyanatoalkylbenzenes, and subsequent hydrolysis of the remaining isocyanate groups. These hardener components may be used individually or in a mixture. These mixtures are available industrially, and permit low-cost preparation of the hardener component.

Heterocyclic polyamines having urea groups can be used as further additive hardener component (i.e. in addition to the actual hardener). The hardener mixture may also use not more than 30% of other aromatic polyamines, such as 4,4′-diaminodiphenylmethane, 4,4′-diaminodiphenyl sulfone, and/or other heterocyclic polyamines.

Preferred other additives present in the inventive fire-protection coating are accelerators, fillers, auxiliaries, blowing agents, nitrogen synergists, carbon donors, pigments, flexibilizers, and/or reactive diluents.

Accelerators which may be used are especially imidazole derivatives, such as 2-methylimidazole, 2-phenylimidazole, and 2-heptadecylimidazole; and also phosphines, tertiary amines, such as benzylmethylamine and tris(dimethylaminomethyl)phenol, and also metal soaps and acetylacetonates.

Examples of fillers and auxiliaries are expandable graphite, boric acid, phosphoric esters, quartz, bolus alba (china clay), chalk, wollastonite, talc, antimony trioxide, glass fibers, mineral fibers, aluminum oxide, aluminum hydroxide, magnesium hydroxide, precipitated silicas, silicates, and/or pulverized celluloses.

Blowing agents and nitrogen synergists are melamine and/or guanidine and salts of these, and/or dicyandiamides. The melamine salts are preferably melamine phosphate, melamine polyphosphate, melamine cyanurate, melamine borate, melamine silicate, and the guanidine salt is preferably guanidine phosphate.

As stated above, the inventive fire-protection coating which forms an insulating layer may comprise from 0 to 60% by weight of additives. Within this range of from 0 to 60% by weight, the quantitative distribution of the additives may be as follows:
Accelerators: from 0 to 25% by weight,
Fillers and auxiliaries: from 0 to 100% by weight,
Blowing agents and nitrogen synergists: from 0 to 100% by weight,
Carbon donors: from 0 to 100% by weight,
Pigments: from 0 to 50% by weight,
Flexibilizers: from 0 to 50% by weight,
Reactive diluents: from 0 to 25% by weight.

The percentage stated for each of the additives is therefore based on the abovementioned 0 to 60% by weight as total.

The nitrogen-containing synergists are preferably those of the formulae (III) to (VIII), or a mixture thereof 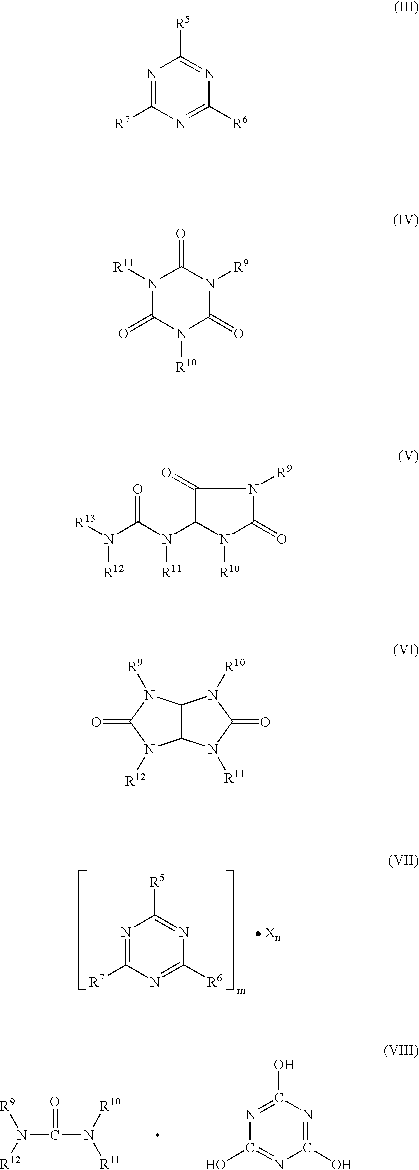
where
   R⁵ to R⁷ are hydrogen, C₁-C₈-alkyl, or C₅-C₁₆-cycloalkyl or -alkylcycloalkyl, optionally substituted with a hydroxy function or with a C₁-C₄— hydroxyalkyl function, C₂-C₈-alkenyl, C₁-C₈-alkoxy, -acyl, -acyloxy, C₆-C₁₂-aryl or -arylalkyl, —OR⁸ or —N(R⁸)R⁹, including systems of alicyclic-N or aromatic-N type,
   R⁸ is hydrogen, C₁-C₈-alkyl or C₅-C₁₆-cycloalkyl or -alkylcycloalkyl, optionally substituted with a hydroxy function or with a C₁-C₄— hydroxyalkyl function, C₂-C₈-alkenyl, C₁-C₈-alkoxy, -acyl, -acyloxy or C₆-C₁₂-aryl or -arylalkyl, R⁹ to R¹³ are the groups of R⁸, or else —O—R⁸,
   m and n, independently of one another, are 1, 2, 3, or 4,
   X is acids which can form adducts with triazine compounds (III); or are oligomeric esters of tris(hydroxyethyl) isocyanurate with aromatic polycarboxylic acids.

It is preferable that the nitrogen-containing synergists are benzoguanamine, tris(hydroxyethyl) isocyanurate, allantoin, glycoluril, melamine, melamine cyanurate, urea cyanurate, dicyandiamide, guanidine.

It is preferable that the nitrogen synergists are condensates of melamine. Examples of condensates of melamine are melem, melam, or melon, or compounds of this type having a higher condensation level, or else mixtures of the same, and by way of example these can be prepared via a process described in WO-A-96/16948.

The fire-protection coating which forms an insulating layer preferably comprises carbohydrates as carbonizing substances.

Carbohydrates preferably used are pentaerythritol, dipentaerythritol, tripentaerythritol, and/or polycondensates of pentaerythritol.

Pigments which may be used are gas black, phthalocyanine pigments, and metal oxides. Titanium dioxide is preferably used as metal oxide.

To improve the toughness of the fire-protection coating, butadiene-acrylonitrile rubber and other aliphatic polymers may be added as flexibilizers.

Examples of reactive diluents which may be used are mono- or polyhydric, low-molecular-weight alcohols which are reacted with epichlorohydrin.

The epoxy resin used for the inventive fire-protection coating is usually composed of an epoxy resin component and of a hardener component.

Bisphenol A, bisphenol F, or a mixture of these is preferred as epoxy resin component, and aliphatic amines are preferred as hardener component.

The present object is likewise achieved via a process for production of intumescent fire-protection coatings from epoxy resins and from the abovementioned flame retardant mixture, which comprises reacting an epoxy resin with the flame retardant mixture and then converting it with a hardener into the fire-protection coating.

The process can, if desired, also use solvents and diluents. Aprotic polar solvents are preferred here. Examples here are: N-methylpyrrolidone, dimethylformamide, ethers, such as diethyl ether, tetrahydrofuran, dioxane, ethyl glycol ethers, propylene glycol ethers, and butyl glycol ethers of monoalcohols having an unbranched or branched alkyl radical of from 1 to 6 carbon atoms.

Examples of other solvents which may be used are ketones, such as acetone, methyl ethyl ketone, methyl isopropyl ketone, methyl isobutyl ketone, cyclohexanone, and the like, and also esters, such as ethyl acetate, butyl acetate, ethylene glycol acetate, and methoxypropyl acetate. Other suitable solvents are halogenated hydrocarbons, and cycloaliphatic and/or aromatic hydrocarbons, preference being given here to hexane, heptane, cyclohexane, toluene, and dixylenes. It is possible to use these solvents individually or in a mixture.

The reaction of the epoxy resin with the flame retardant mixture (component A+B) and with the hardener preferably takes place at temperatures of −10 to +150° C.

The invention likewise provides the use of the abovementioned fire-protection coatings. These inventive fire-protection coatings are preferably used for coating load-bearing and non-load-bearing metallic structures or forms. The inventive fire-protection coatings can also be used to protect floorcoverings, walls, or moldings from stresses caused by temperature.

The inventive fire-protection coatings have good flame retardancy and are simple to process. The preferred method here mixes the epoxy resin and the hardener components, or the constituents which comprise them, shortly prior to application. In another preferred method, the systems comprising the epoxy resin and the systems comprising the hardener components are heated slightly in order to reduce viscosity. This simplifies spray application—preferably by the airless method. Typically, the systems to be heated are heated to from 50° C. to 75° C., and the temperature of the systems to be heated should preferably be from 65° C. to 70° C. directly prior to application.

In the following examples, intumescent fire-protection coatings are produced and their effectiveness is determined. The thermal insulation capability of the intumescent fire-protection coatings was tested in a small test rig by analogy with DIN4102 Part 8 (1986), using the heating curve by analogy with ISO834 (1975). Thermogravimetric evaluation of the flame retardant mixture was carried by an analytical method using a “NETZSCH STA 409C” thermal balance.

### EXAMPLES 1 to 5

The following products were used in the examples:

®Exolit AP422 (Clariant GmbH)

®Exolit AP422 is a free-flowing, pulverulent ammonium polyphosphate of the formula (NH₄PO₃)ₙ, where n=from 20 to 1000, in particular from 200-1000, which is sparingly soluble in water.

®Exolit AP750 (Clariant GmbH)

This is a halogen-free flame retardant mixture which comprises polymeric ammonium polyphosphate in combination with aromatic carboxylic esters of tris(2-hydroxyethyl) isocyanurate as synergists.

®Exolit OP1230 (Clariant GmbH)

®Exolit OP1230 is a fine-grained, non-hygroscopic powder based on an organic phosphinate and insoluble in water and in familiar organic solvents.

®Beckopox EP140 (UCB-Surface Specialties)

This is a low-molecular-weight condensate composed of bisphenol A and epichlorohydrin with density of 1.16 g/ml (at 25° C.) and with an epoxy equivalent weight of from 180-190.

®Beckopox EH624 (UCB-Surface Specialties)

This is an aliphatic polyamine whose active-H equivalent weight is 80 g/mol, with a dynamic viscosity of from 2300-3800 mPas (at 23° C.).

Tronox® R-KB-5 (Kerr Mc-Gee Chemical LLC)

This is a rutile-type titanium dioxide which was stabilized with Al₂O₃, and the surface was treated with Al components and with Zr components.

Optibor® Boric Acid (Deutsche Borax GmbH)

This is a pure boric acid of the formula (H₃BO₃)

### Example 1

### Comparison

100 parts of Beckopox EP 140, 25 parts of boric acid, 2 parts of TiO₂, and 100 parts of Exolit AP422 were introduced in succession in a stirred vessel and, after adequate mixing, reacted with 43 parts of Beckopox EH 624. The resultant fire-protection coating was applied to one side of a steel plate (St 37) measuring 280×280×6 mm, using a roller. The composition cured for one day at room temperature, and its layer thickness was determined as 3.5 mm.

The surface of the coating was smooth and free from cracks.

The fire test on the coated sheet to DIN 4102 gave a fire resistance of 33 minutes. The reaction started at T=240° C.

### Example 2

### Comparison

The fire-protection coating used was the same as that used in Example 1, but Exolit AP750 was used instead of Exolit AP422. The resultant fire-protection coating was applied to one side of a steel plate (St 37) measuring 280×280×6 mm, using a roller. The composition cured for one day at room temperature, and its layer thickness was determined as 3.5 mm.

The surface of the coating was smooth and free from cracks.

The fire test on the coated sheet to DIN 4102 gave a fire resistance of 41 minutes. The reaction started at T=220° C.

### Example 3

### Invention

100 parts of Beckopox EP 140, 25 parts of boric acid, 9 parts of tris(hydroxyethyl) isocyanurate, 2 parts of TiO₂, and 5 parts of a disparate flame retardant mixture composed of Exolit AP422 and Exolit OP1230 were introduced in a stirred vesssel and, after adequate mixing, reacted with 43 parts of Beckopox EH 624. The resultant fire-protection coating was applied to one side of a steel plate (St 37) measuring 280×280×6 mm, using a roller. The composition cured for one day at room temperature, and its layer thickness was determined as 3.5 mm.

The surface of the coating was smooth and free from cracks.

The fire test on the coated sheet to DIN 4102 gave a fire resistance of 44 minutes. The reaction started at T=179° C.

### Example 4

### Erfindung

100 parts of Beckopox EP 140, 25 parts of boric acid, 9 parts of tris(hydroxyethyl) isocyanurate, 2 parts of TiO₂, and 60 parts of a disparate flame retardant mixture composed of Exolit AP422 and Exolit OP1230 were introduced in a stirred vesssel and, after adequate mixing, reacted with 43 parts of Beckopox EH 624. The resultant fire-protection coating was applied to one side of a steel plate (St 37) measuring 280×280×6 mm, using a roller. The composition cured for one day at room temperature, and its layer thickness was determined as 3.5 mm.

The surface of the coating was smooth and free from cracks.

The fire test on the coated sheet to DIN 4102 gave a fire resistance of 49 minutes. The reaction started at T=175° C.

### Example 5

100 parts of Beckopox EP 140, 25 parts of boric acid, 9 parts of tris(hydroxyethyl) isocyanurate, 2 parts of TiO₂, and 140 parts of a disparate flame retardant mixture composed of Exolit AP422 and Exolit OP1230 were introduced in a stirred vesssel and, after adequate mixing, reacted with 43 parts of Beckopox EH 624. The resultant fire-protection coating was applied to one side of a steel plate (St 37) measuring 280×280×6 mm, using a roller. The composition cured for one day at room temperature, and its layer thickness was determined as 3.5 mm.

The surface of the coating was smooth and free from cracks.

The fire test on the coated sheets to DIN 4102 gave a fire resistance of 59 minutes. The reaction started at T=164° C.

### Example 6

The fire-protection coating produced was the same as that produced in Example 5, but the application thickness was 2.0 mm. The surface of the coating was smooth and free from cracks.

The fire test on the coated sheet to DIN 4102 gave a fire resistance of 42 minutes. The reaction started at T=166° C.

### Example 7

### Invention

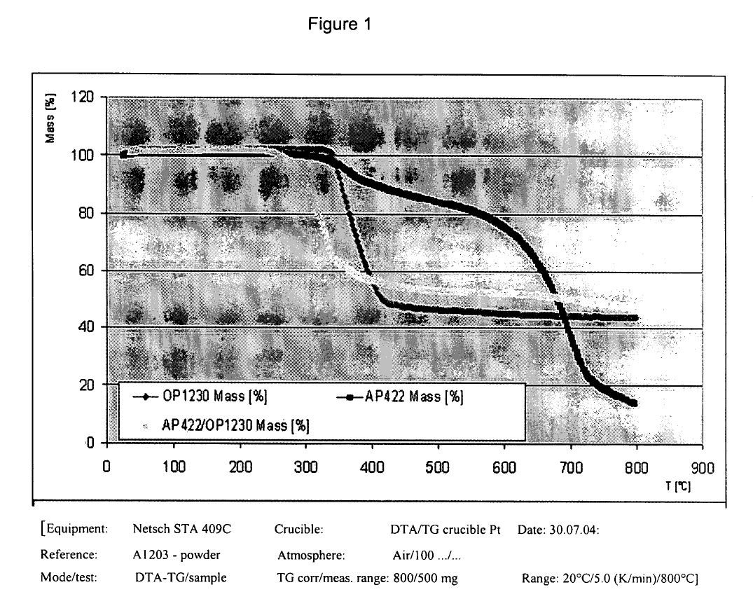

The flame retardant mixture from Examples 3 and 4, and also the individual components Exolit AP422 and Exolit OP1230 present therein, were compared thermogravimetrically. The significantly earlier start of the reaction of the flame retardant mixture shows the synergy when comparison is made with the individual components (FIG. 1).

1. A fire-protection coating which forms an insulating layer, comprising a flame retardant mixture wherein the flame retardant mixture includes a phosphorus/nitrogen flame retardant and a phosphinic salt of the formula (I) a diphosphinic salt of the formula (II) a polymer of the phosphinic salt, a polymer of the diphosphinic salt, or a mixture thereof, 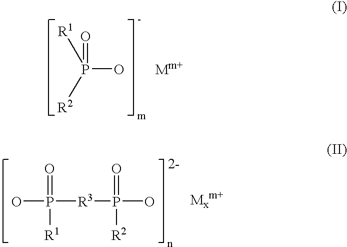
wherein
R¹, R² are identical or different and are C₁-C₆-alkyl, linear or branched, or aryl;
R³ is C₁-C₁₀-alkylene, linear or branched, C₆-C₁₀-arylene, -alkylarylene or -arylalkylene;
M is Mg, Ca, Al, Sb, Sn, Ge, Ti, Zn, Fe, Zr, Ce, Bi, Sr, Mn, Li, Na, K or a protonated nitrogen base;
m is from 1 to 4; n is from 1 to 4 and x is from 1 to 4.

2. The fire-protection coating which forms an insulating layer, as claimed in claim 1, wherein the phosphorus/nitrogen flame retardant is a nitrogen-containing phosphate of the formulae (NH4)y H3-y PO₄ or (NH4 PO3)z, where y is from 1 to 3 and z is from 1 to 10 000.

3. The fire-protection coating which forms an insulating layer, as claimed in claim 1, wherein the phosphorus/nitrogen flame retardant is ammonium hydrogenphosphate, ammonium dihydrogenphosphate, ammonium polyphosphate, or a mixture thereof.

4. The fire-protection coating which forms an insulating layer, as claimed in claim 1, wherein the phosphorus/nitrogen flame retardant is an ammonium polyphosphate of the formula (NH₄PO₃)ₙ, where n is a number from 10 to ≦1000.

5. The fire-protection coating which forms an insulating layer, as claimed in claim 1, wherein the phosphorus/nitrogen flame retardant is the reaction products of melamine with phosphoric acid or condensed phosphoric acids, the reaction products of condensates of melamine with phosphoric acid or with condensed phosphoric acids, or a mixture of thereof.

6. The fire-protection coating which forms an insulating layer, as claimed in claim 5, wherein the phosphorus/nitrogen flame retardant is melam, melem, melon, dimelamine phosphate, dimelamine pyrophosphate, melamine phosphate, melamine pyrophosphate, melamine polyphosphate, melam polyphosphate, melon polyphosphate, melem polyphosphate, mixed polysalts thereof or mixtures thereof.

7. The fire-protection coating which forms an insulating layer, as claimed in claim 1, wherein the ratio, by weight, of the phosphorus/nitrogen flame retardant to the phosphinic salt of the formula (I), the diphosphinic salt of the formula (II), the polymer of the phosphinic salt, the polymer of the diphosphinic salt or mixtures thereof is from 0.1 to 100 to 100 to 0.1.

8. The fire-protection coating which forms an insulating layer, as claimed in claim 1, wherein the ratio, by weight, of the phosphorus/nitrogen flame retardant to the phosphinic salt of the formula (I), the diphosphinic salt of the formula (II), the polymer of the phosphinic salt, the polymer of the diphosphinic salt or mixtures thereof is from 1 to 50 to 50 to 1.

9. The fire-protection coating which forms an insulating layer, as claimed in claim 1 comprising:
A) from 1 to 99% by weight of an epoxy resin,
B) from 1 to 99% by weight of the flame retardant mixture, and
C) from 0 to 60% by weight of an additive.

10. The fire-protection coating which forms an insulating layer, as claimed in claim 1, comprising:
A) from 10 to 90% by weight of an epoxy resin,
B) from 2 to 60% by weight of a the flame retardant mixture, and
C) from 3 to 45% by weight of an additive.

11. The fire-protection coating which forms an insulating layer, as claimed in claim 1, comprising
A) from 30 to 85% by weight of an epoxy resin,
B) from 3 to 50% by weight of the flame retardant mixture, and
C) from 5 to 40% by weight of an additive.

12. The fire-protection coating which forms an insulating layer, as claimed in claim 1, further comprising from 0 to 60% by weight of at least one additive selected from the group consisting of accelerators, fillers, auxiliaries, blowing agents, nitrogen synergists, carbon donors, pigments, flexibilizers, reactive diluents and mixtures thereof.

13. (canceled)

14. The fire-protection coating which forms an insulating layer, as claimed in claim 1, wherein M is calcium, aluminum, or zinc.

15. The fire-protection coating which forms an insulating layer, as claimed in claim 1, wherein R¹ and R² are identical or different and are methyl, ethyl, n-propyl, isopropyl, n-butyl, tert-butyl, n-pentyl, or phenyl.

16. The fire-protection coating which forms an insulating layer, as claimed in claim 1, wherein R³ is methylene, ethylene, n-propylene, isopropylene, n-butylene, tert-butylene, n-pentylene, n-octylene, n-dodecylene; phenylene, naphthylene; methylphenylene, ethylphenylene, tert-butylphenylene, methylnaphthylene, ethylnaphthylene, tert-butylnaphthylene; phenylmethylene, phenylethylene, phenylpropylene, or phenylbutylene.

17. The fire-protection coating which forms an insulating layer, as claimed in claim 4, wherein n is a number from 200 to ≦1000.

18. A substrate coated with the fire-protection coating which forms an insulating layer, as claimed in claim 1.

19. The substrate as claimed in claimed 18, wherein the substrate is a floorcovering, molding, wall, load-bearing metallic structure or a non-load-bearing metallic structure.
